(19) United States
(12) Patent Application Publication
(10) Pub. No.: US 2003/0172593 A1
(43) Pub. Date: Sep. 18, 2003

(54) Replacement silo access closure assembly with recessed panel mounted access door and breaker bar

(76) Inventor: Kenneth D. Musser, Mount Joy, PA (US)

Correspondence Address: Michael R. Swartz, Esq., 205 Royal Oak Avenue, Pittsburgh, PA, 15235, US

(21) Appl. No.: 10/387,910

(22) Filed: Mar. 13, 2003

Related U.S. Application Data
(60) Provisional application No. 60/364,684, filed on Mar. 15, 2002.

(51) Int. Cl. E06B 7/00

(52) U.S. Cl. 49/463; 49/465; 49/57

(57) ABSTRACT

A replacement silo access closure assembly includes a removable closure for closing an access opening in a silo having a recessed central panel and an access hole defined in the panel, an access door mounted on a first side of the panel at an exterior side of the silo and being movable between opened and closed positions relative to the access hole in the panel, and a breaker bar mounted on a second side of the panel at the interior side of the silo and opposite from the first side of the panel and being located above the access hole in the panel.

This utility patent application claims the benefit of provisional application No. 60/364,684 filed Mar. 15, 2002.

### BACKGROUND OF THE INVENTION

1. Field of the Invention

The present invention generally relates to closures provided for accessing the interior of a storage silo just above ground level and, more particularly, is concerned with a replacement silo access closure assembly with a recessed panel mounted access door and breaker bar.

2. Description of the Prior Art

Silos widely in use are large tall containers for storing feed or forage materials in a tightly packed column. One widely used silo which is glass lined is known by the brand name “Harvestore”. Located at the bottom of this silo, and also many others, is an unloader used for unloading the forage material from the silo. Typically, the unloader has a discharge conveyor disposed in a covered radial channel, below floor level, running from an inlet location at the center of the silo to a discharge location through the peripheral outer wall of the silo. The unloader also has a rotatable or pivotal sweep arm conveyor which moves in a plane just above floor level so as to loosen and separate forage material from the bottom of the packed column thereof and transfer the separated forage material to the central inlet location of the discharge conveyor.

The sweep arm conveyor of the unloader employs various movable components, for example chains, paddles and augers, for loosening, separating and transferring forage material. These components are potentially sites of a high degree of wear unless periodic maintenance is provided to service them.

Particularly, lubricating oil must be supplied to these components at regular time intervals in order to reduce significantly the degree of wear that would otherwise occur.

Most silos typically have access closures on the side thereof adjacent to the unloader for providing access to the unloader, when the silo is empty for making major repairs of the unloader. However, the utility of such access closures is substantially reduced when the silo contains a dense or compact column of forage material. The presence of the compact forage material obstructs or impedes the opening of the closure or once the closure is opened requires the digging out of considerable forage material to reach the movable chain of the swing arm. These circumstances discourage the desired frequent lubrication and servicing of the swing arm conveyor of the unloader.

Most newer unloaders have a built-in lubricating system which eliminates this problem of the impracticality of accessing the swing arm conveyor of the unloader in the storage silo that contains forage material. However, older unloaders still in wide use have no such lubricating system and so the accessibility problem is left unresolved.

Consequently, there is a need for an innovation that overcome the accessibility problem without introducing any new problems in place thereof.

### SUMMARY OF THE INVENTION

The present invention provides a replacement silo access closure assembly designed to satisfy the aforementioned need. The replacement silo access closure assembly of the present invention has a removable closure with a recessed central panel, an access door pivotally mounted on an exterior side of the panel, and a breaker bar mounted on an interior side of the panel above an access hole formed through the panel and extends into the interior of the silo. The breaker bar functions to prevent forage material from compacting or packing around the access door so as to facilitate an operator opening the access door and reaching through the access hole and push away loose, as opposed to packed, forage material in order to service the swing arm conveyor of the unloader. The recessed construction of the central panel places the access door closer to the swing arm conveyor than in the case of prior art flat closure.

Accordingly, the present invention is directed to a replacement silo access closure assembly which comprises a removable closure for closing an access opening in a silo defined by an annular structure of a silo located between interior and exterior sides of the silo. The removable closure has a peripheral flange mountable to the annular structure of the silo and a central panel recessed relative to the peripheral flange toward the interior side of the silo. The central panel has an access hole defined therethrough. The closure assembly also comprises an access door mounted on a first side of the central panel of the removable closure at the exterior side of the silo and being movable away from and toward the first side of the central panel and the exterior side of the silo between opened and closed positions relative to the access hole in the central panel. The closure assembly further comprises a breaker bar mounted on a second side of the central panel of the removable closure opposite from the first side and at the interior side of the silo and projecting outwardly from the second side of the central panel and away from the interior side of the silo and into the interior of the silo. The breaker bar also is located above the access hole of the central panel.

More particularly, the peripheral flange of the removable closure has spaced apart inner and outer edges and the central panel is fixedly attached to the inner edge of the peripheral flange such that the central panel is recessed away from the outer edge of the peripheral flange and toward the interior side of the silo. The closure assembly still further comprises a latch mounted on the first side of the central panel of the removable closure adjacent to the access door and is movable between latched and unlatched positions relative to the access door when the access door is at the closed position over the access hole for securing the access door at the closed position and releasing the access door for movement away from the closed position. The breaker bar has upper and lower portions fixedly attached together and extending at an acute angle with respect to one another. Also, the central panel of the removable closure has an upper portion and a lower portion. The breaker bar is disposed generally horizontally along and mounted to the upper portion of the central panel at the second side thereof whereas the access door is disposed along and mounted to the lower portion of the central panel below the breaker bar and on the first side of the central panel.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is a front elevational view of a conventional silo in which the replacement silo access closure assembly of the present invention can be utilized.

FIG. 2 is an enlarged fragmentary front elevational view of the silo of FIG. 1 showing the bottom portion of the silo having an access opening formed therein and an end of a discharge conveyor of an unloader in the silo extending from the silo below the access opening and below floor level of the silo.

FIG. 3 is a view similar to that of FIG. 2 but now showing a prior art flat panel closure covering the access opening of the silo.

FIG. 4 is a vertical sectional view taken along line 4-4 of FIG. 3 showing the presence of compacted forage material behind the flat panel closure covering the access opening and between the closure and the sweep arm conveyor of the unloader in the silo.

FIG. 5 is an enlarged fragmentary front elevational view of the silo similar to that of FIG. 3 but now showing the replacement silo access closure assembly of the present invention covering the access opening of the silo.

FIG. 6 is a vertical sectional view taken along line 6-6 of FIG. 5 showing the presence of loose forage material behind a recessed central panel of a removable closure of the closure assembly and between the closure assembly and the sweep arm conveyor of the unloader in the silo.

FIG. 7 is a perspective view of the replacement silo access closure assembly of the present invention removed from the silo.

FIG. 8 is a front elevational view of the closure assembly of FIG. 7.

FIG. 9 is a horizontal sectional view of the closure assembly taken along line 9-9 of FIG. 8 showing the removable closure with an access door pivotally mounted on an exterior side of the central panel being in a closed position.

FIG. 10 is a view similar to that of FIG. 9 now showing the removable closure mounted to the access opening of the silo and with the access door pivotally mounted to an opened position.

### DETAILED DESCRIPTION OF THE INVENTION

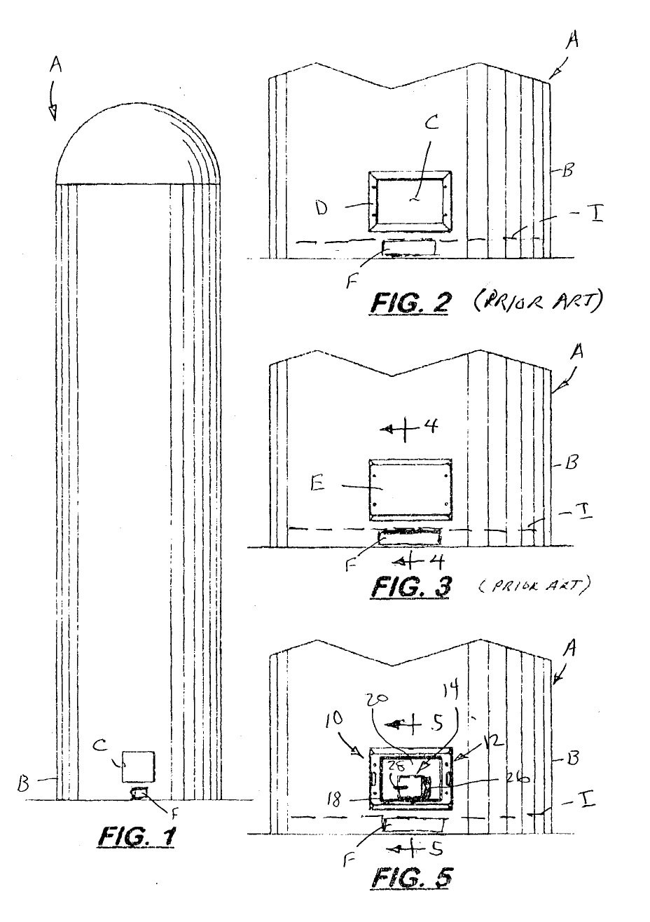

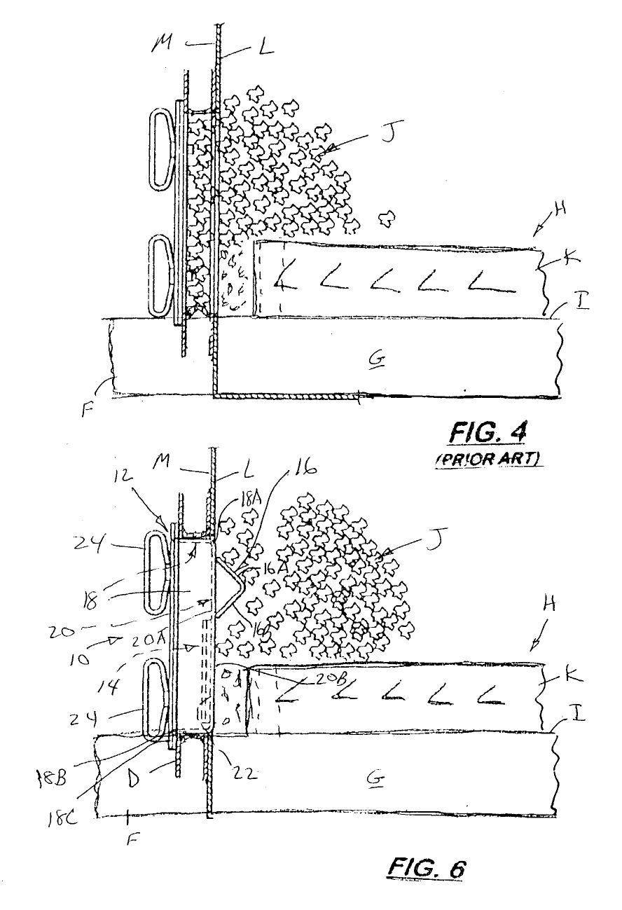

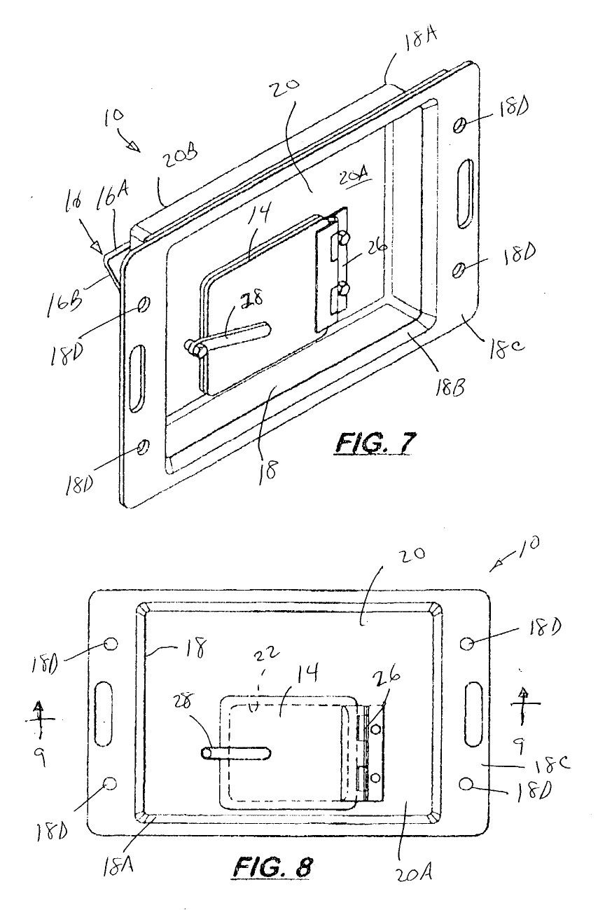

Referring to the drawings and more particularly to FIGS. 1-4, there is illustrated a prior art silo A in which a replacement silo access closure assembly of the present invention, generally designated 10 in FIGS. 5-10, can be utilized. A bottom portion B of the silo A has an access opening C formed by an annular structure D, as best seen in FIG. 2, on the silo A and covered by a removable flat closure E attached to the annular structure D and extending over the access opening C, as best seen in FIG. 3. As best seen in FIG. 4, an end F of a discharge conveyor G of an unloader H in the silo A extends from the silo A below the access opening C and to the middle of the silo A below the floor level I of the silo A. Also, the presence of compacted or tightly packed forage material J is shown in FIG. 4 behind the flat closure E and covering the access opening C and extending between the closure E and a sweep arm conveyor K of the unloader H located above the floor level I in the silo A. The presence of the packed forage material J impedes removal by the operator of the flat closure E and the operator from reaching the sweep arm conveyor K.

Referring now to FIGS. 5-10, there is illustrated the replacement silo access closure assembly 10 of the present invention. The closure assembly 10 basically includes a removable closure 12, an access door 14 and a breaker bar 16. The removable closure 12 of the closure assembly 10 is provided for closing the access opening C in the silo A defined by the annular structure D of the silo A located between interior and exterior sides L, M of the silo A. The removable closure 12 has an annular peripheral flange 18 mountable to the annular structure D of the silo A and a central panel 20 recessed relative to the peripheral flange 18 toward the interior side L of the silo A. The central panel 20 has an access hole 22 defined through it. More particularly, the peripheral flange 18 has spaced apart inner and outer edges 18A, 18B. The central panel 20 is fixedly attached to the inner edge 18A of the peripheral flange 18B such that the central panel 20 is recessed away from the outer edge 18B of the peripheral flange 18 and toward the interior side L of the silo A. The peripheral flange 18 has a front rim 18C attached to and extending about its outer edge 18B with thru-openings 18D defined therethrough in opposite portions of the front rim 18C. The assembly further includes a pairs of threaded fasteners 24, for example wing nut bolts as

### DETAILED DESCRIPTION OF THE INVENTION

Referring to the drawings and more particularly to FIGS. 1-4, there is illustrated a prior art silo A in which a replacement silo access closure assembly of the present invention, generally designated 10 in FIGS. 5-10, can be utilized. A bottom portion B of the silo A has an access opening C formed by an annular structure D, as best seen in FIG. 2, on the silo A and covered by a removable flat closure E attached to the annular structure D and extending over the access opening C, as best seen in FIG. 3. As best seen in FIG. 4, an end F of a discharge conveyor G of an unloader H in the silo A extends from the silo A below the access opening C and to the middle of the silo A below the floor level I of the silo A. Also, the presence of compacted or tightly packed forage material J is shown in FIG. 4 behind the flat closure E and covering the access opening C and extending between the closure E and a sweep arm conveyor K of the unloader H located above the floor level I in the silo A. The presence of the packed forage material J impedes removal by the operator of the flat closure E and the operator from reaching the sweep arm conveyor K.

Referring now to FIGS. 5-10, there is illustrated the replacement silo access closure assembly 10 of the present invention. The closure assembly 10 basically includes a removable closure 12, an access door 14 and a breaker bar 16. The removable closure 12 of the closure assembly 10 is provided for closing the access opening C in the silo A defined by the annular structure D of the silo A located between interior and exterior sides L, M of the silo A. The removable closure 12 has an annular peripheral flange 18 mountable to the annular structure D of the silo A and a central panel 20 recessed relative to the peripheral flange 18 toward the interior side L of the silo A. The central panel 20 has an access hole 22 defined through it. More particularly, the peripheral flange 18 has spaced apart inner and outer edges 18A, 18B. The central panel 20 is fixedly attached to the inner edge 18A of the peripheral flange 18B such that the central panel 20 is recessed away from the outer edge 18B of the peripheral flange 18 and toward the interior side L of the silo A. The peripheral flange 18 has a front rim 18C attached to and extending about its outer edge 18B with thru-openings 18D defined therethrough in opposite portions of the front rim 18C. The assembly further includes a pairs of threaded fasteners 24, for example wing nut bolts as seen in FIG. 10, which extend through the thru-openings 18D for threaded engagement with corresponding internally threaded holes (not shown) provided in the annular structure D for releasably securing the removable closure 12 at the peripheral flange 18 thereof to the annular structure D of the silo A encompassing the assess opening.

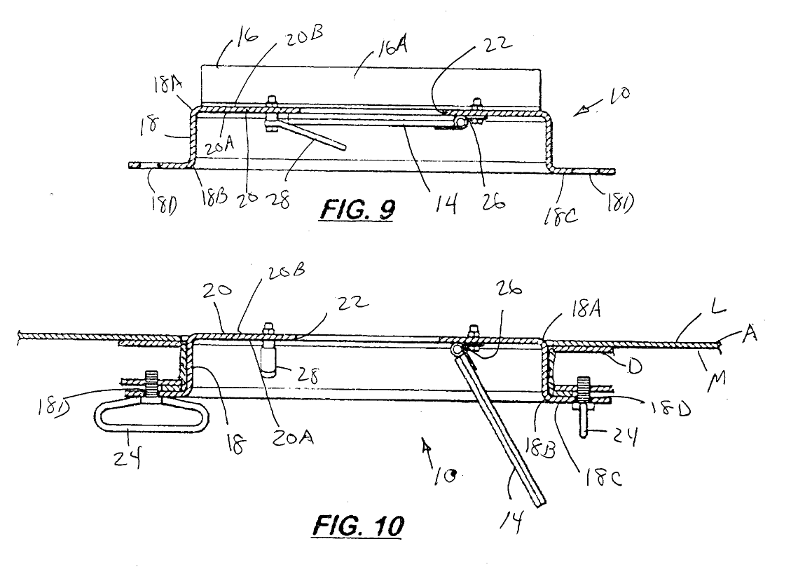

The access door 14 of the closure assembly 10 is mounted on a first or exterior side 20A of the central panel 20 of the removable closure 12 at the exterior side M of the silo A. The access door 14 is mounted by hinge 26 for undergoing pivotal movement away from and toward the exterior side 20A of the central panel 20 and exterior side M of the silo A between opened and closed positions, as seen respectively in FIGS. 10 and 9, relative to the access hole 22 in the central panel 20. The closure assembly 10 further includes a latch 28 mounted on the exterior side 20A of the central panel 20 adjacent to the access door 14 and is movable between latched and unlatched positions, as seen in FIGS. 9 and 10, relative to the access door 14 when the access door 14 is at the closed position shown in FIG. 9, for securing the access door 14 at the closed position and releasing the access door 14 for movement away from the closed position overlying the access hole 22.

The breaker bar 16 of the closure assembly 10 is mounted on a second or interior side 20B of the central panel 20 of the removable closure 10 opposite from the first or exterior side 20A and at the interior side L of the silo A. The breaker bar 16 has upper and lower portions 16A, 16B which are fixedly attached together and to the central panel 20 such that they extend therefrom at an acute angle, such as about ninety degrees as shown in FIG. 6, with respect to one another and thereby project outwardly from the interior side of the central panel 20 and away from the interior side 20B of central panel 20 and the interior side L of the silo A. Also, the breaker bar 16 is disposed generally horizontally and located on an upper portion 20C of the central panel 20 above the access hole 22 defined in a lower portion 20D of the central panel 20 and thus the access door 14 at the exterior side 20A of the central panel 20.

As readily seen in FIG. 6, the breaker bar 16 functions to prevent forage material J from compacting or packing around the access door 14 so as to facilitate an operator opening the access door 14 and reaching through the access hole 22 in the central panel 20 and pushing away loose, as opposed to packed, closer to the swing arm conveyor K than in the case of prior art flat closure E.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. A replacement silo access closure assembly for mounting across an access opening in a silo, comprising:
(a) a removable closure for closing the access opening in the silo, said removable closure having a peripheral flange having spaced apart inner and outer edges and being mountable to the silo about the access opening and a central panel fixedly attached to said inner edge of said peripheral flange such that said central panel is recessed relative to said outer edge of said peripheral flange toward an interior side of the silo; and
(b) a breaker bar mounted on a side of said central panel of said removable closure opposite from said peripheral flange and at the interior side of the silo and projecting from said side of said central panel past and away from the interior side of the silo and into the interior of the silo.

2. The assembly as recited in claim 1, wherein:
said central panel has an upper portion and a lower portion; and
said breaker bar is disposed generally horizontally along and mounted to said upper portion of said central panel.

3. The assembly as recited in claim 1, further comprising:
a plurality of fasteners releasably fastening said removable closure at said peripheral flange thereof to said silo.

4. The assembly as recited in claim 3, wherein said fasteners are wing nut bolts.

5. The assembly as recited in claim 1, wherein said breaker bar has upper and lower portions fixedly attached together and extending at an acute angle with respect to one another.

6. A replacement silo access closure assembly for mounting across an access opening in a silo, comprising:
(a) a removable closure for closing the access opening in the silo, said removable closure having a peripheral flange having spaced apart inner and outer edges and being mountable to the silo about the access opening and a central panel fixedly attached to said inner edge of said peripheral flange such that said central panel is recessed relative to said outer edge of said peripheral flange toward an interior side of the silo, said central panel having an access hole therethrough; and
(b) an access door mounted on a first side of said central panel of said removable closure adjacent to said peripheral flange of said removable closure and opposite to the interior side of said silo for undergoing movement away from and toward said access hole in said central panel of said removable closure between opened and closed positions relative to said access hole.

7. The assembly as recited in claim 6, further comprising:
a latch mounted on said first side of said central panel of said removable closure adjacent to said access door and being movable between latched and unlatched positions relative to said access door when said access door is at said closed position for securing said access door at said closed position and releasing said access door from movement away from said closed position.

8. The assembly as recited in claim 6, further comprising:
a breaker bar mounted on a second side of said central panel of said removable closure opposite from said peripheral flange and said first side of said central panel and projecting from said second side of said central panel past and away from the interior side of the silo and into the interior of the silo.

9. The assembly as recited in claim 8, wherein said breaker bar has upper and lower portions fixedly attached together and extending at an acute angle with respect to one another.

10. The assembly as recited in claim 8, wherein:
said central panel of said removable closure has an upper portion and a lower portion; and
said breaker bar is disposed generally horizontally along and mounted to said upper portion of said central panel at said second side thereof.

11. The assembly as recited in claim 10, wherein:
said access door is disposed along and mounted to said lower portion of said central panel of said removable closure below said breaker bar and on said first side of said central panel.

12. The assembly as recited in claim 6, further comprising:
a plurality of fasteners releasably fastening said removable closure at said peripheral flange thereof to said silo.

13. A replacement silo access closure assembly for mounting across an access opening in a silo, comprising:
(a) a removable closure for closing the access opening in the silo, said removable closure having upper and lower portions and an access hole defined therethrough in said lower portion;
(b) an access door mounted on said lower portion and at a first side of said removable closure opposite to an interior side of said silo for undergoing movement away from and toward said first side of said removable closure and an exterior side of the silo between opened and closed positions relative to said access hole in said central panel of said removable closure; and
(c) a breaker bar mounted on said upper portion and at a second side of said central panel of said removable closure opposite from said first side thereof and at the interior side of the silo and projecting from said central panel past and away from the interior side of the silo and into the interior of the silo.

14. The assembly as recited in claim 13, further comprising:
a latch mounted on said lower portion and at said first side of said central panel of said removable closure adjacent to said access door and being movable between latched and unlatched positions relative to said access door when said access door is at said closed position for securing said access door at said closed position and releasing said access door from movement away from said closed position.

15. The assembly as recited in claim 13, wherein said breaker bar has upper and lower portions fixedly attached together and extending at an acute angle with respect to one another.

16. The assembly as recited in claim 13, further comprising:
a plurality of fasteners releasably fastening said removable closure at said peripheral flange to said silo.
